(19) United States
(12) Patent Application Publication
(10) Pub. No.: US 2026/0155436 A1
(43) Pub. Date: Jun. 4, 2026

(54) LITHIUM-ION CONDUCTOR, LITHIUM BATTERY INCLUDING THE SAME, AND METHOD OF PREPARING LITHIUM-ION CONDUCTOR

(71) Applicant: SAMSUNG ELECTRO-MECHANICS CO., LTD., Suwon-si (KR)

(72) Inventors: Sungjin LIM, Suwon-si (KR); Giyun KWON, Suwon-si (KR); Taeyoung KIM, Suwon-si (KR); Taehee KIM, Suwon-si (KR); Hwiyeol PARK, Suwon-si (KR); Insun JUNG, Suwon-si (KR)

(21) Appl. No.: 19/404,586

(22) Filed: Dec. 1, 2025

(30) Foreign Application Priority Data
Dec. 4, 2024 (KR) 10-2024-0178987
Nov. 28, 2025 (KR) 10-2025-0186140

(51) Int. Cl. H01M 10/0562; C03C 3/23; C03C 4/18; H01M 10/0525

(52) U.S. Cl. CPC H01M 10/0562; C03C 3/23; C03C 4/18; H01M 10/0525; H01M 2300/008

(57) ABSTRACT

A lithium-ion conductor and an all-solid-state battery including the lithium-ion conductor. The lithium-ion conductor including: a first compound represented by Formula 1; and a second compound represented by Formula 2, wherein the lithium-ion conductor has a first peak at a diffraction angle (2θ) of 23.8° to 24.5° in an X-ray diffraction spectrum:

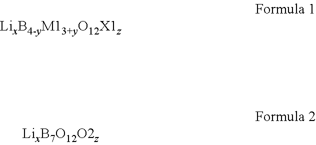

wherein Formula 1 and Formula 2 are as described herein.

### CROSS-REFERENCE TO RELATED APPLICATION

This application claims priority to Korean Patent Applications No. 10-2024-0178987, filed on Dec. 4, 2024, and No. 10-2025-0186140, filed on Nov. 28, 2025 in the Korean Intellectual Property Office, and all the benefits accruing therefrom under 35 U.S.C. § 119, the disclosure of which in its entirety is incorporated by reference herein.

### BACKGROUND

### 1. Field

The disclosure relates to a lithium-ion conductor, a lithium battery including the lithium-ion conductor, and a method of preparing the lithium-ion conductor.

### 2. Description of the Related Art

Recent industrial demands require batteries having high energy density. Lithium batteries have such high energy density and are used in wireless earphones, mobile devices, and electric vehicles. Conventional lithium batteries employ liquid electrolytes including flammable organic solvents, so there is a risk of overheating and fire in the event of a short circuit. Considering this risk, all-solid-state lithium batteries using a solid electrolyte instead of a liquid electrolyte are of interest and under development.

Oxide-based solid electrolytes are relatively stable in air as compared to sulfide-based solid electrolytes that require isolation from air.

### SUMMARY

An aspect of the disclosure provides a novel lithium-ion conductor having excellent ionic conductivity and moisture stability.

Another aspect of the disclosure provides a solid battery including the lithium-ion conductor.

Additional aspects will be set forth in part in the description which follows and, in part, will be apparent from the description, or may be learned by practice of the presented embodiments of the disclosure.

According to an aspect, a lithium-ion conductor includes: a first compound represented by Formula 1; and a second compound represented by Formula 2, wherein the lithium-ion conductor has a first peak at a diffraction angle (2θ) of about 23.8° to about 24.5° in an XRD spectrum:

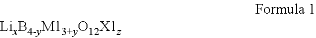

wherein, in Formula 1,
3.8≤x≤4.2, 0≤y<4, and 0.5≤z≤1.2,
M1 is at least one element belonging to groups 13 to 15 of Periodic Table, and
X1 is at least one halogen element,

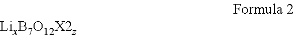

wherein, in Formula 2,
3.8≤x≤4.2 and 0.5≤z≤1.2, and
X2 is at least one halogen element.

According to another aspect, a lithium battery includes: a cathode; an anode; and a solid electrolyte layer disposed between the cathode and the anode, wherein at least one of the cathode, the anode, and the solid electrolyte layer includes the lithium-ion conductor.

According to another aspect, a method of preparing a lithium-ion conductor includes:
preparing a precursor glass including lithium, boron, an M1 element, and a halogen element;
annealing the precursor glass to prepare an intermediate; and
pressurizing and heat-treating the intermediate to prepare a lithium-ion conductor including a crystal phase,
wherein the lithium-ion conductor includes: a first compound represented by Formula 1; and a second compound represented by Formula 2,
wherein the lithium-ion conductor has a first peak at a diffraction angle (2θ) of about 23.8° to about 24.5° in an XRD spectrum:

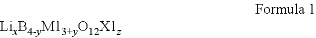

wherein, in Formula 1,
3.8≤x≤4.2, 0≤y<4, and 0.5≤z≤1.2,
M1 is at least one element belonging to groups 13 to 15 of Periodic Table, and
X1 is at least one halogen element,

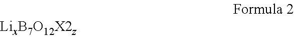

wherein, in Formula 2,
3.8≤x≤4.2 and 0.5≤z≤1.2, and
X2 is at least one halogen element.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a series of X-ray diffraction spectra of lithium-ion conductors prepared in Example 1 and Comparative Examples 1 and 2;

FIG. 2 is a partially expanded view of the XRD spectra FIG. 1;

FIG. 3 is a plot illustrating the lattice parameters of lithium-ion conductors prepared in Examples 1 to 5 and Comparative Examples 1 to 2;

FIG. 4 is a plot illustrating the results of measuring the phase fractions of lithium-ion conductors prepared in Examples 1 to 5 and Comparative Examples 1 to 2;

FIG. 5 is a cross-sectional view schematically illustrating the structure of a solid battery according to an embodiment;

FIG. 6 is a cross-sectional view schematically illustrating the structure of a solid battery according to an embodiment; and

FIG. 7 is a cross-sectional view schematically illustrating the structure of a solid battery according to an embodiment.

FIG. 8 is a cross-sectional view schematically illustrating the structure of a laminated ceramic battery according to an embodiment;

FIG. 9 is a cross-sectional view schematically illustrating the structure of a laminated ceramic battery according to another embodiment; and

FIG. 10 is a cross-sectional view schematically illustrating the structure of a laminated ceramic battery according to another embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Rather, these embodiments are provided so that this disclosure will be thorough and complete, and are provided to fully transfer the scope of the inventive idea to those skilled in the art. Identical reference numerals indicate identical components. Accordingly, the embodiments are merely described below, by referring to the figures, to explain aspects.

When a component is referred to as being located “on or over” another component, it can be understood that it may be located directly on another component, or that another component may intervene therebetween. In contrast, when a component is referred as being located “directly on” another component, no component may intervene therebetween.

Although the terms “first,” “second,” “third,” etc. may be used herein to describe various components, ingredients, areas, layers, and/or regions, these components, ingredients, areas, layers, and/or regions should not be limited by these terms. These terms are used only to distinguish one component, ingredient, area, layer or region from another component, ingredient, area, layer or region. Accordingly, the first component, ingredient, area, layer or region, described below, May be referred to as a second component, ingredient, area, layer or region without departing from the scope of the present disclosure.

The terms used in this disclosure are for the purpose of describing only particular embodiments and are not intended to limit the inventive concept. As used herein, the singular form is intended to include the plural form including “at least one,” unless the context clearly dictates otherwise. “At least one” should not be construed as limiting to the singular number. The terms “include” and/or “including” as used in the detailed description specify the presence of stated features, regions, integers, steps, operations, components and/or ingredients, but do not preclude the presence or addition of one or more other features, regions, integers, steps, operations, components, ingredients and/or groups thereof.

Unless otherwise defined, all terms (including technical and scientific terms) used in this disclosure have the same meaning as that commonly understood by those skilled in the art to which this disclosure belongs. Additionally, terms defined in commonly used dictionaries should be interpreted as having a meaning consistent with their meaning within the context of the relevant art and the present disclosure, and should not be interpreted in an idealized or overly formal sense.

Exemplary embodiments are described in the present disclosure with reference to cross-sectional views which are schematic diagrams of idealized embodiments. Likewise, for example, variations in the illustrated shape must be expected as a result of manufacturing techniques and/or tolerances. Therefore, the embodiments described in this disclosure should not be construed as limited to the specific shapes of regions as illustrated in this disclosure, and should include, for example, deviations in shapes resulting from manufacturing. For example, a region illustrated or described as flat may typically have rough and/or non-linear features. Moreover, sharply illustrated angles may be rounded. Accordingly, the regions illustrated in the drawings are schematic in nature, and their shapes are not intended to illustrate the precise shape of the regions and are not intended to limit the scope of the claims.

“Group” refers to a group in Periodic Table of the elements according to the International Union of Pure and Applied Chemistry (“IUPAC”) Group 1-18 classification system.

As used herein, the “particle diameter” refers to an average diameter when a particle is spherical and refers to an average major axis length when the particle is non-spherical. The particle diameter may be measured using a particle size analyzer (PSA). “Particle diameter” is, for example, an average particle diameter. “Average particle diameter” is, for example, a median particle diameter, D50.

D50 is a size of the particle corresponding to 50% of the cumulative volume, calculated from the side of the particle with the smaller particle size in the size distribution of the particles measured by laser diffraction.

D90 is a size of the particle corresponding to 90% of the cumulative volume, calculated from the side of the particle with the smaller particle size in the size distribution of the particles measured by laser diffraction.

D10 is a size of the particle corresponding to 10% of the cumulative volume, calculated from the side of the particle with the smaller particle size in the size distribution of the particles measured by laser diffraction.

As used herein, the “lithium-ion conductor” refers to a material having a lithium-ion conductivity of 1×10⁻⁷ siemens per centimeter (S/cm) or more at room temperature and normal pressure.

As used herein, the “metal” includes both metals and metalloids such as silicon and germanium, under an elemental state or an ionic state.

As used herein, the “alloy” refers to a mixture of two or more metals.

As used herein, the “electrode active material” refers to an electrode material capable of undergoing lithiation and delithiation.

As used herein, the “cathode active material” refers to a cathode material capable of undergoing lithiation and delithiation.

As used herein, the “anode active material” refers to an anode material capable of undergoing lithiation and delithiation.

As used herein, the “lithiation” and “lithiating” refers to a process of adding lithium to an electrode active material.

As used herein, the “delithiation” and “delithiate” refers to a process of removing lithium from an electrode active material.

As used herein, the “charge” and “charging” refers to a process of providing electrochemical energy to a battery.

As used herein, the “discharge” and “discharging” refers to a process of removing electrochemical energy to a battery.

As used herein, the “positive electrode” and “cathode” refers to an electrode at which electrochemical reduction and lithiation occur during a discharge process.

As used herein, the “negative electrode” and “anode” refers to an electrode at which electrochemical oxidation and delithiation occur during a discharge process.

Although specific embodiments have been described, alternatives, modifications, variations, improvements, and substantial equivalents, which are not currently anticipated or cannot be anticipated, may occur to applicants or those skilled in the art. Accordingly, the appended claims, as filed and as amended, are intended to encompass all such alternatives, modifications, variations, improvements and substantial equivalents.

A solid battery using an oxide-based solid electrolyte as a lithium-ion conductor are manufactured by sintering, and sintering at relatively low temperature is required to prevent or minimize side reactions between the oxide-based solid electrolyte and an electrode active material during the sintering process. Because a glass solid electrolyte has a relatively low sintering temperature, glass solid electrolytes are likely more suitable for manufacturing a solid battery, but there are technical disadvantages as well. For instance, glass solid electrolyte tends to have relatively low ionic conductivity and relatively low moisture stability compared to a crystalline solid electrolyte. Accordingly, a lithium-ion conductor having excellent ionic conductivity and moisture stability while sintering at low temperatures is required.

Hereinafter, a lithium-ion conductor and an all-solid-state battery including the same according to embodiments will be described in more detail.

### Lithium-Ion Conductor

According to an embodiment, a lithium-ion conductor includes a first compound represented by Formula 1; and a second compound represented by Formula 2, wherein the lithium-ion conductor has a first peak at a diffraction angle (2θ) of 23.8° to 24.5° in an X-ray diffraction (XRD) spectrum:

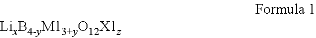

wherein, in Formula 1,
3.8≤x≤4.2, 0≤y<4, and 0.5≤z≤1.2,
M1 is at least one element belonging to groups 13 to 15 of Periodic Table, and
X1 is at least one halogen element,

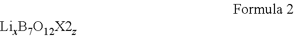

wherein, in Formula 2,
3.8≤x≤4.2 and 0.5≤z≤1.2, and
X2 is at least one halogen element.

In Formula 1, for example, 3.9≤x≤4.1, 0≤y≤3, and 0.5≤z≤1.2. In Formula 1, for example, 3.9≤x≤4.1, 0≤y≤2, and 0.5≤z≤1.2. In Formula 1, for example, 3.9≤x≤4.1, 0≤y≤1, and 0.6≤z≤1.1. In Formula 1, for example, 3.9≤x≤4.1, 0≤y≤1, and 0.7≤z≤1.1. In Formula 1, for example, 3.9≤x≤4.1, 0≤y≤1, and 0.8≤z≤1.1. In Formula 1, for example, 3.9<x≤4.1, 0≤y≤1, and 0.9≤z≤1.1. In Formula 1, for example, 3.95≤x≤4.05, 0≤y≤0.5, and 0.95≤z≤1.05.

In Formula 2, for example, 3.9≤x≤4.1 and 0.5≤z≤1.2. In Formula 2, for example, 3.9≤x≤4.1 and 0.6≤z≤1.2. In Formula 2, for example, 3.9≤x≤4.1 and 0.6≤z≤1.1. In Formula 2, for example, 3.9≤x≤4.1 and 0.7≤z≤1.1. In Formula 2, for example, 3.9≤x≤4.1 and 0.8≤z≤1.1. In Formula 2, for example, 3.9≤x≤4.1 and 0.9≤z≤1.1. In Formula 2, for example, 3.95≤x≤4.05 and 0.95≤z≤1.05.

In the XRD spectrum of the lithium-ion conductor, the position of the first peak may be, for example, a diffraction angle (2θ) of about 23.80° to about 24.30°, a diffraction angle (2θ) of about 23.80° to about 24.10°, or a diffraction angle (2θ) of about 23.83° to about 24.00°. In the XRD spectrum of the lithium-ion conductor, the lithium-ion conductor may has a second peak having a diffraction angle less than the diffraction angle of the first peak.

The lithium-ion conductor may include a first compound and a second compound, and may also include an additional (third compound) compound exhibiting a peak distinct from that of the first compound and the second compound (i.e., a first peak), thereby providing the lithium-ion conductor improved ionic conductivity. The lattice of the additional compound exhibiting the first peak may have a lattice parameter that is reduced compared to the lattice of the first compound, thereby providing a buffer effect between the lattices of the first compound. Due to this buffer effect, an energy barrier for the conduction of lithium-ions within the crystal structure of the lithium-ion conductor may be reduced. As a result, the lithium-ion conductor may have improved ionic conductivity. In addition, the internal resistance of an all-solid-state battery including such a lithium-ion conductor may be reduced, thereby improving the charge/discharge characteristics of the all-solid-state battery.

Since the lithium-ion conductor includes an additional compound exhibiting a first peak and having structural stability, the content of amorphous phases having relatively high reactivity with moisture may be significantly reduced, or these phases may not exist. As a result, the lithium-ion conductor may have improved moisture stability. The moisture-induced deterioration of an all-solid-state battery including such a lithium-ion conductor may be suppressed.

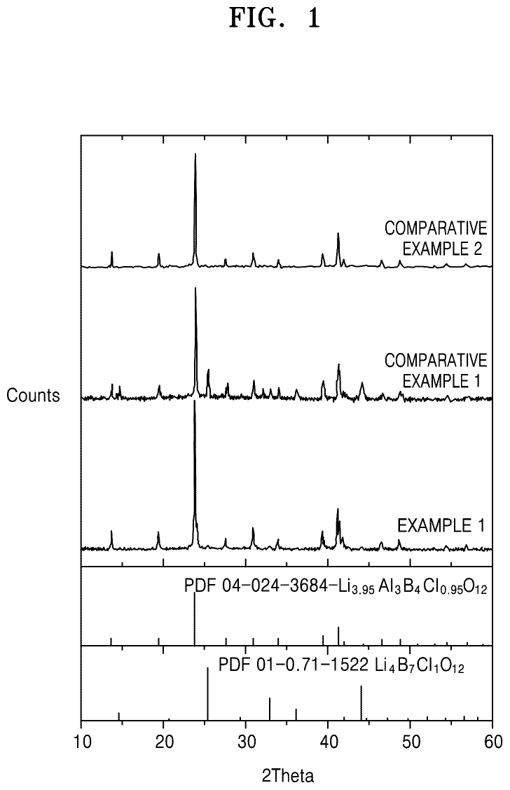

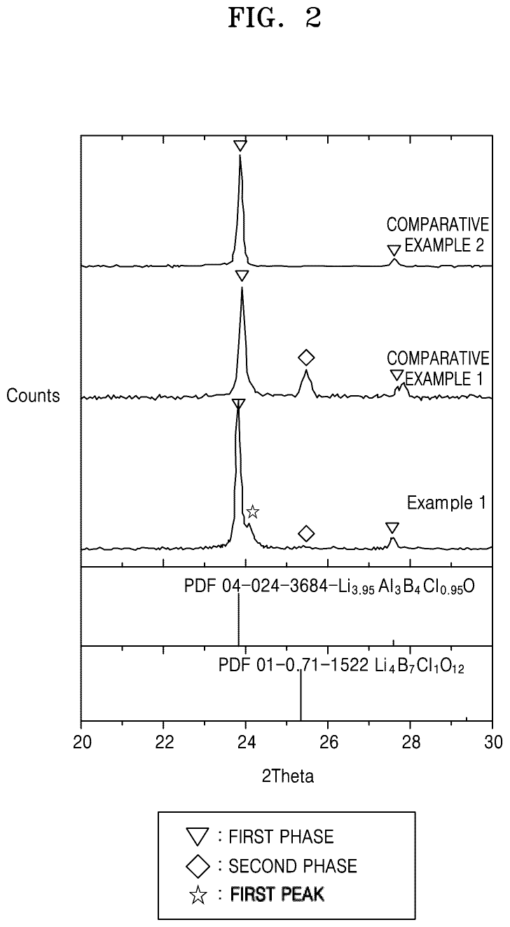

Referring to FIGS. 1 and 2, the lithium-ion conductor may have a first peak at a diffraction angle (2θ) of 23.8° to 24.5° and a second peak at a diffraction angle (2θ) of 23.8±0.3° derived from the first compound in an XRD spectrum. A ratio (Ic/Ia) of intensity Ic of the first peak to intensity Ia of the second peak, that is, a first peak intensity ratio (Ic/Ia) may be, for example, 0.05 or more, 0.07 or more, or 0.1 or more. The first peak intensity ratio (Ic/Ia) may be, for example, about 0.05 to about 0.5, about 0.07 to about 0.4, or about 0.1 to about 0.3. Without further limitation to the lithium-ion conductor, it is believed that because the lithium-ion conductor has the first peak intensity ratio (Ic/Ia) in this range, further improved ionic conductivity and moisture stability may be provided.

Referring to FIGS. 1 and 2, the lithium-ion conductor may have a first peak at a diffraction angle (2θ) of 23.8° to 24.5° and a third peak at a diffraction angle (2θ) of 25.3±0.5° derived from the second compound in the XRD spectrum. A ratio (Ic/Ib) of intensity Ic of the first peak to intensity Ib of the third peak, that is, a second peak intensity ratio (Ic/Ib), may be, for example, 0.1 or more, 0.3 or more, 0.5 or more, 0.8 or more, 1 or more, 2 or more, or 3 or more. The second peak intensity ratio (Ic/Ib) may be, for example, about 0.1 to about 100, about 0.3 to about 100, about 0.5 to about 100, about 0.8 to about 100, about 1 to about 100, about 2 to about 20, or about 3 to about 10. Since the lithium-ion conductor has the second peak intensity ratio (Ic/Ib) in this range, further improved ionic conductivity and moisture stability may be provided.

The lithium-ion conductor has a first peak appearing at a diffraction angle (2θ) of 23.8° to 24.5° in the XRD spectrum. The first peak may be derived from a third compound. The third compound may have, for example, physical properties and/or chemical compositions that are distinct from the first compound and the second compound. The third compound may have, for example, a lattice parameter that is distinct from the first compound and the second compound.

The lithium-ion conductor includes a first compound and a third compound, and the first compound and the third compound may have a cubic structure. Since the first compound and the third compound have a cubic structure, the a-axis, b-axis, and c-axis may have the same lattice parameters. The a-axis lattice parameter of the third compound may be, for example, about 12.580 Å to about 12.940 Å, about 12.580 Å to about 12.900 Å, about 12.580 Å to about 12.870 Å, or about 12.580 Å to about 12.850 Å. Since the third compound has an a-axis lattice parameter in this range, the ionic conductivity and moisture stability of the lithium-ion conductor including the third compound may be improved.

The a-axis lattice parameter of the third compound may be smaller than the a-axis lattice parameter of the first compound. The a-axis lattice parameter of the first compound may be, for example, 12.910 Å or more or 12.945 Å or more. Since the a-axis lattice parameter of the third compound is smaller than the a-axis lattice parameter of the first compound, a buffer effect may be provided between the a-axis lattice parameters. For example, since the positions of atoms arranged in the cubic crystal structure within the lithium-ion conductor including the first compound and the third compound are partially modified, an energy barrier for the conduction of lithium-ions within the lithium-ion conductor may be lowered. As a result, the lithium-ionic conductivity of the lithium-ion conductor may be improved.

The lithium-ion conductor includes, for example, a first phase including the first compound, a second phase including the second compound, and a third phase including the third compound, wherein a phase fraction of the third phase may be 3 wt % or more, 7 wt % or more, 9 wt % or more, 12 wt % or more, or 15 wt % or more with respect to the total weight of the first phase, the second phase, and the third phase. The phase fraction of the third phase in the lithium-ion conductor may be, for example, about 3 wt % to about 40 wt %, about 7 wt % to about 40 wt %, about 9 wt % to about 35 wt %, about 12 wt % to about 30 wt %, or about 15 wt % to about 30 wt % with respect to the total weight of the first phase, the second phase, and the third phase. Without further limitation to the lithium-ion conductor, it is believed that because the lithium-ion conductor has a third phase fraction in this range, the lithium-ion conductor may have improved ionic conductivity and moisture stability.

The lithium-ion conductor may include, for example, a first phase and a third phase, wherein the first phase includes a first compound represented by Formula 1, and the third phase may include a third compound including boron (B), at least one element (M1) belonging to groups 13 to 15 of Periodic Table, and oxygen (O). The third compound is distinguished from the first compound. The third phase may include a third compound including, for example, lithium (Li), boron (B), at least one element (M1) belonging to groups 13 to 15 of Periodic Table, oxygen (O), and a halogen. At least one element (M1) belonging to groups 13 to 15 of Periodic Table may be, for example, Al, Si, P, Ga, Ge, As, In, Sn, Sb, Tl, Pb, Bi, or a combination thereof. The halogen may be, for example, F, Cl, Br, I or a combination of thereof. Lattice parameters and phase fractions may be calculated by Rietveld refinement using information about all peaks obtained, for example, from an XRD spectrum.

The lithium-ion conductor includes, for example, a first compound and a third compound, wherein the third compound may have a content of boron (CB) with respect to the content (CM1) of at least one element belonging to groups 13 to 15 of Periodic Table more than that of the first compound. For example, a content ratio (C3_{B}/C3_{M1}) of the content of boron (C3_{B}) to the content of at least one element (C3_{M1}) belonging to Groups 13 to 15 of Periodic Table in the third compound may be greater than a ratio (C1_{B}/C1_{M1}) of the content of boron (C1_{B}) to the content of at least one element (C1_{M1}) belonging to groups 13 to 15 of Periodic Table in the first compound. That is, the B/M1 ratio in the third phase may be greater than the B/M1 ratio in the first phase. The content ratio may be a mole ratio. For example, the ratio in third phase (C3_{B}/C3_{M1}) to the ratio in first phase (C1_{B}/C1_{M1}), that is, (C3_{B}/C3_{M1}):(C1_{B}/C1_{M1}), may be, for example, 1.01:1.00 or more, 1.05:1.00 or more, 1.10:1.00 or more, 1.20:1.00 or more, or 1.50:1.00 or more.

The lithium-ion conductor may include, for example, a first phase and a third phase, wherein the third phase may include a third compound. The third compound may include, for example, 3 moles to 5 moles of lithium; more than 4 moles to less than 7 moles of boron; more than 0 to less than 3 moles of at least one element belonging to groups 13 to 15 of Periodic Table; 11 moles to 13 moles of oxygen; and 0.5 moles to 1.2 moles of a halogen element, with respect to 1 mole of the third compound. The third compound may include, for example, 3.5 moles to 4.5 moles of lithium; more than 4 moles to less than 6 moles of boron; more than 1 mole to less than 3 moles of at least one element belonging to groups 13 to 15 of Periodic Table; 11.5 moles to 12.5 moles of oxygen; and 0.7 moles to 1.1 moles of a halogen element, with respect to 1 mole of the third compound. The third compound may include, for example, 3.7 moles to 4.3 moles of lithium; more than 4 moles to less than 5 moles of boron; more than 2 moles to less than 3 moles of at least one element belonging to groups 13 to 15 of Periodic Table; 11.7 moles to 12.3 moles of oxygen; and 0.8 moles to 1.05 moles of a halogen element, with respect to 1 mole of the third compound. The third compound may include, for example, 3.9 moles to 4.1 moles of lithium; more than 4 moles to less than 4.5 moles of boron; 2.5 moles to less than 3 moles of at least one element belonging to groups 13 to 15 of Periodic Table; 11.9 moles to 12.1 moles of oxygen; and 0.9 moles to 1.01 moles of a halogen element, with respect to 1 mole of the third compound.

The third compound may be, for example, a compound represented by Formula 3:

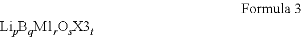

wherein, in Formula 3,
3≤p≤5, 4≤q<7, 0<r<3, 11≤s≤13, and 0.5≤t≤1.2,
M1 is at least one element belonging to groups 13 to 15 of Periodic Table, and
X3 is at least one halogen element.

In Formula 3, for example, 3.5≤p≤4.5, 4<q≤6, 1≤r<3, 11.5≤s≤12.5, and 0.7≤t≤1.1. In Formula 3, for example, 3.7≤p≤4.3, 4<q≤5, 2≤r<3, 11.7≤s≤12.3, and 0.8≤t≤1.05. In Formula 3, for example, 3.9≤p≤4.1, 4<q≤4.5, 2.5≤r<3, 11.9≤s≤12.1, and 0.9≤t≤1.01. In Formula 3, at least one element (M1) belonging to groups 13 to 15 of Periodic Table may be, for example, Al, Si, P, Ga, Ge, As, In, Sn, Sb, Tl, Pb, Bi, or a combination thereof. In Formula 3, the halogen may be, for example, F, Cl, Br, I, or a combination thereof.

The third compound may include, for example, compounds represented by Formulae 3a to 3e:

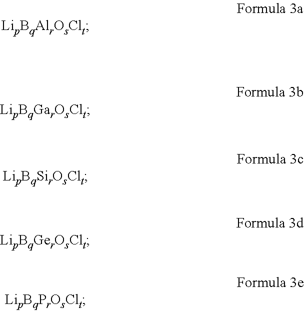

In Formulae 3a to 3e; 3≤p≤5, 4<q<7, 0<r<3, 11≤s≤13, and 0.6≤t≤1.2. In Formulae 3a to 3e, for example, 3.5≤p≤4.5, 4≤q≤6, 1≤r<3, 11.5≤s≤12.5, and 0.7≤t≤1.1. In Formulae 3a to 3e, for example, 3.7≤p≤4.3, 4<q≤5, 2≤r<3, 11.7≤s≤12.3, and 0.8≤t≤1.05. In Formulae 3a to 3e, for example, 3.9≤p≤4.1, 4<q≤4.5, 2.5≤r<3, 11.9≤s≤12.1, and 0.9≤t≤1.01.

The third compound may include, for example, compounds represented by Formulae 3f to 3j:

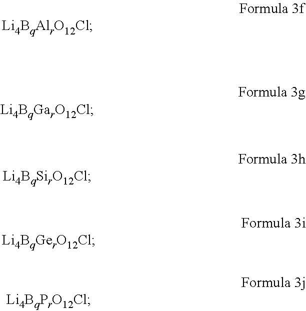

In Formulae 3f to 3j, 4<q<7 and 0<r<3. In Formulae 3f to 3j, for example, 4<q≤6 and 1≤r≤3. In Formulae 3f to 3j, for example, 4<q≤5 and 2≤r<3. In Formulae 3f to 3j, for example, 4<q≤4.5 and 2.5≤r<3.

The lithium-ion conductor includes a first phase, a second phase, and a third phase, wherein the first phase includes a first compound, the second phase includes a second compound and the third phase includes a third compound.

The first compound may be represented, for example, by Formula 4, and the second compound may be represented, for example, by Formula 5:

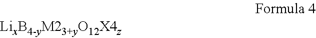

In Formula 4,
3.9≤x≤4.1, 0≤y<3 and 0.9≤z≤1.1,
M2 is Al, Ga, Si, Ge, P, or a combination of thereof, and
X4 is F, Cl, Br, I, or a combination of thereof,

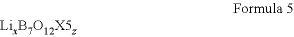

In Formula 5,
3.9≤x≤4.1 and 0.9≤z≤1.1, and
X5 is F, Cl, Br, I, or a combination of thereof.

The first compound may be represented, for example, by Formula 6, and the second compound may be represented, for example, by Formula 7:

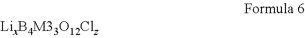

in Formula 6,
3.9≤x≤4.1 and 0.7≤z≤1.1, and
M3 is Al, Ga, Si, Ge, P, or a combination of thereof,

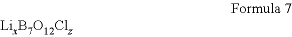

in Formula 7,
3.9≤x≤4.1 and 0.7≤z≤1.1.

The first compound may include, for example, Li₄B₄Al₃O₁₂Cl, Li₄B₄Ga₃O₁₂Cl, Li₄B₄Si₃O₁₂Cl, Li₄B₄Ge₃O₁₂Cl, Li₄B₄P₃O₁₂Cl, or a combination thereof. The second compound may include, for example, Li₄B₇O₁₂Cl.

The lithium-ion conductor may further include, for example, an amorphous phase, a glass phase, or a combination thereof in addition to the first phase, the second phase, and the third phase. Without further limitation to the lithium-ion conductor, it is believed that because the lithium-ion conductor further includes an amorphous phase, a glass phase, or a combination thereof, for example, the sintering temperature of the lithium-ion conductor may be more easily lowered.

The phase fraction of the amorphous phase included in the lithium-ion conductor may be 2 wt % or less, 1 wt % or less, or 0.1 wt % or less with respect to the total weight of the first phase, the second phase, the third phase, and the amorphous phase included in the lithium-ion conductor. Without further limitation to the lithium-ion conductor, it is believed that because the lithium-ion conductor has a low phase fraction of the amorphous phase, the ionic conductivity and/or moisture stability of the lithium-ion conductor may be further improved.

The phase fraction of the glass phase included in the lithium-ion conductor may be 2 wt % or less, 1 wt % or less, or 0.1 wt % or less with respect to the total weight of the first phase, the second phase, the third phase, and the glass phase included in the lithium-ion conductor. Without further limitation to the lithium-ion conductor, it is believed that because the lithium-ion conductor has a low phase fraction of the glass phase, the ionic conductivity and/or moisture stability of the lithium-ion conductor may be further improved.

The phase fraction of the amorphous phase and glass phase included in the lithium-ion conductor may be 2 wt % or less, 1 wt % or less, or 0.1 wt % or less with respect to the total weight of the first phase, the second phase, the third phase, the amorphous phase, and the glass phase included in the lithium-ion conductor. Without further limitation to the lithium-ion conductor, it is believed that because the lithium-ion conductor has a low phase fraction of the amorphous phase and glass phase, the ionic conductivity and/or moisture stability of the lithium-ion conductor may be further improved.

Alternatively, the lithium-ion conductor may not substantially include, for example, an amorphous phase, a glassy phase, or a combination thereof. For example, in an XRD spectrum for a lithium-ion conductor one or more of an amorphous phase, a glassy phase, may not be detected.

The lithium-ion conductor may have, for example, an ionic conductivity of 3.7×10⁻⁶ siemens per centimeter (S/cm) or more, 4.0×10⁻⁶ S/cm or more, 5.0×10⁻⁶ S/cm or more, or 5.5×10⁻⁶ S/cm or more at 20° C. and 1 atm. Without further limitation to the lithium-ion conductor, it is believed that because the lithium-ion conductor has such ionic conductivity, the charge/discharge characteristics of an all-solid-state battery including the lithium-ion conductor may be improved. The ionic conductivity of the lithium-ion conductor may be measured, for example, by impedance analysis.

The lithium-ion conductor may have a moisture absorption rate of 30% or less or 25% or less, which corresponds to a mass increase rate due to moisture absorbed after being left for 7 days at a relative humidity of 70%. Without further limitation to the lithium-ion conductor, it is believed that because the lithium-ion conductor has such a low moisture absorption rate, improved moisture stability may be provided. Therefore, the deterioration due to moisture in an all-solid-state battery including the lithium-ion conductor may be more effectively suppressed. In addition, since the need for moisture blocking is reduced during the manufacturing of the lithium-ion conductor, manufacturing costs may be reduced, and the lithium-ion conductor may be manufactured more easily under various conditions.

According to an embodiment, in an XRD spectrum, the lithium-ion conductor may have a first peak and a second peak at a diffraction angle (2θ) of 23.5° to 24.5° and may have a third peak at a diffraction angle (2θ) of 25.3±0.5°. Specifically, the lithium-ion conductor may have a first peak at a diffraction angle (2θ) of 23.8° to 24.5°, a second peak at a diffraction angle (2θ) smaller than the diffraction angle of the first peak, and a third peak at a diffraction angle (2θ) of 25.3±0.5°. The second peak may appear at a diffraction angle (2θ) of 23.8±0.3°.

### Method of Preparing Lithium-Ion Conductor

According to another embodiment, a method of preparing a lithium-ion conductor includes the processes of: preparing a precursor glass including lithium, boron, an M1 element, and a halogen element; annealing the precursor glass to prepare an intermediate; and pressurizing and heat-treating the intermediate to prepare a lithium-ion conductor including a crystal phase. A lithium-ion conductor prepared by this method comprises a first compound represented by Formula 1; and a second compound represented by Formula 2, and has a first peak at a diffraction angle (2θ) of 23.8° to 24.5° in an XRD spectrum:

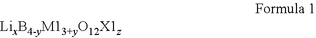

in Formula 1,
3.8≤x≤4.2, 0≤y<4, and 0.5≤z≤1.2,
M1 is at least one element belonging to groups 13 to 15 of Periodic Table, and
X1 is at least one halogen element,

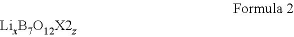

in Formula 2,
3.8≤x≤4.2 and 0.5≤z≤1.2,
M1 is at least one element belonging to groups 13 to 15 of Periodic Table, and
X2 is at least one halogen element.

Without further limitation to the lithium-ion conductor, it is believed that because the precursor glass is crystallized through annealing followed by pressuring and heat-treating, a lithium-ion conductor having a peak at a diffraction angle (2θ) of 23.8° to 24.5° in an XRD spectrum may be formed. Therefore, a lithium-ion conductor manufactured by this method may provide excellent ionic conductivity and improved moisture stability.

First, a precursor glass including lithium, boron, an M1 element, and a halogen element is prepared. The process of preparing the precursor glass including lithium, boron, an M1 element, and a halogen element may include: preparing a mixture including a lithium precursor, a boron precursor, an M1 precursor, and a halogen precursor; heat-treating the mixture to prepare a molten product; and cooling the molten product to prepare the precursor glass.

In an embodiment, a mixture including a lithium precursor, a boron precursor, an M1 precursor, and a halogen precursor is prepared. The lithium precursor may include, for example, a lithium-containing oxide, a lithium-containing hydroxide, a lithium-containing carbonate, a lithium-containing halogen salt, or a combination thereof. The lithium precursor may be, for example, Li₂O, LiOH, Li₂CO₃, or the like.

The boron precursor may include, for example, a boron-containing oxide. The boron precursor may be, for example, B₂O₃.

The M1 precursor may include, for example, an M1-containing oxide, an M1-containing hydroxide, an M1-containing carbonate, or a combination thereof. The M1 precursor may be, for example, Al₂O₃, P₂O₅, SiO₂, GeO₂, Ga₂O₃, or a combination thereof.

The halogen precursor may be, for example, a lithium-containing halide. The halogen precursor may be, for example, LiCl, LiBr, LiF, LiI, or the like.

An oxygen precursor may optionally be added separately. Among the lithium precursors, boron precursors, M1 precursors and halogen precursors described above, a precursor containing oxygen may be used as an oxygen precursor.

The contents of the lithium precursor, boron precursor, M1 precursor and halogen precursor included in the mixture may be adjusted depending on the required composition of the lithium-ion conductor.

The mixture may include, for example, 2 mole equivalents to 4 mole equivalents of the lithium precursor, 3 mole equivalents to 5 mole equivalents of the boron precursor, and 2 mole equivalents to 4 mole equivalents of the M1 precursor per 1 mole equivalent of the halogen precursor.

The mixture may include, for example, 2 mole equivalents to 4 mole equivalents of the lithium precursor, 2.5 mole equivalents to 3.5 mole equivalents of the lithium precursor, and 2.7 mole equivalents to 3.2 mole equivalents of the lithium precursor per 1 mole equivalent of the halogen precursor.

The mixture may include, for example, 3 mole equivalents to 5 mole equivalents of the boron precursor, 3.5 mole equivalents to 4.5 mole equivalents of the boron precursor, and 3.7 mole equivalents to 4.3 mole equivalents of the boron precursor per 1 mole equivalent of the halogen precursor.

The mixture may include, for example, 2 mole equivalents to 4 mole equivalents of the M1 precursor, 2.5 mole equivalents to 3.5 mole equivalents of the M1 precursor, and 2.7 mole equivalents to 3.2 mole equivalents of the M1 precursor per 1 mole equivalent of the halogen precursor.

The prepared mixture is heat-treated to prepare a molten product.

The heat treatment for preparing the molten product may be performed, for example, at about 700° C. to about 1300° C. for about 1 minute to about 10 hours. The heat treatment may be carried out in an air atmosphere or in an inert atmosphere.

The prepared molten product is cooled to prepare a precursor glass.

The precursor glass may be prepared by, for example, pouring or spreading the molten product onto a room-temperature metal substrate and then additionally placing a room-temperature metal substrate on the molten product to cool the molten product.

The cooling rate and cooling temperature may be controlled to conditions under which a precursor glass including an amorphous phase or a glass phase is formed.

The precursor glass may be formed into various shapes for use in a subsequent annealing process.

After the process of preparing the precursor glass, the method may further include: milling the precursor glass to prepare precursor glass power; and molding the precursor glass powder to prepare a molded body, e.g., forming a pellet.

The process of milling the precursor glass to prepare precursor glass power may be performed by mechanical milling. The mechanical milling includes, but is not limited to, ball milling, jet milling, and the like, and any method capable of performing mechanical milling in the related technical field is possible. The mechanical milling may be performed dry in an inert atmosphere for about 10 minutes to about 100 hours. The mechanical milling may be performed in an air atmosphere or in an inert atmosphere. The inert atmosphere may be an atmosphere substantially free of oxygen. The inert atmosphere may be an atmosphere including nitrogen, argon, neon, or a combination thereof.

The process of molding the precursor glass powder to prepare a molded body may be performed by adding the precursor glass powder into a mold having a certain shape and then pressurizing the mold. The shape of the molded body may be, for example, a pellet, a film, or the like.

Next, the precursor glass in its molded form is annealed to prepare an intermediate. The precursor glass may have a pellet shape. The annealing may be performed by heat treatment at a temperature of about 200° C. to about 650° C. for about 10 minutes to about 10 hours. The annealing may be performed in an air atmosphere or an inert atmosphere. An intermediate may be prepared by the annealing. The intermediate may have crystallinity, composition, and the like that are distinct from the precursor glass. The annealing may be performed at atmospheric pressure.

Next, the intermediate is pressurized and heat-treated to prepare a lithium-ion conductor. The pressurizing and heat treatment may be performed at a pressure ranging from about 50 megapascals (MPa) to about 500 MPa. The pressurizing and heat treatment may be performed in an air atmosphere or an inert atmosphere. A lithium-ion conductor may be prepared by the pressurizing and heat treatment. The pressurizing and heat treatment may be performed by heat treatment under pressure at a temperature of about 200° C. to about 700° C. for about 10 minutes to about 10 hours. The above-described lithium-ion conductor is prepared by the pressurizing and heat treatment of the intermediate.

The method may further include an additional annealing process. The additional annealing may be performed by heat treatment at a temperature of about 200° C. to about 650° C. for about 10 minutes to about 10 hours. The additional annealing may be performed in an air atmosphere or an inert atmosphere. The crystallinity of the lithium-ion conductor may be further improved by the additional annealing. The additional annealing may be performed at atmospheric pressure. The additional annealing may be omitted.

### Lithium Battery

According to another embodiment, a lithium battery includes a cathode; an anode; and a solid electrolyte layer disposed between the cathode and the anode, wherein at least one of the cathode, the anode, and the solid electrolyte layer includes the above-described lithium-ion conductor. Without further limitation to the lithium-ion conductor, it is believed that because the lithium battery includes the above-described lithium-ion conductor, the internal resistance of the lithium battery can be reduced, and the cycle characteristics and moisture stability of an all-solid-state battery can be improved.

The lithium battery may be used in electronic devices, vehicles, and the like, but it may also be used for other purposes. The lithium battery is not particularly limited, and may be, for example, a lithium-ion battery, a lithium air battery, or the like.

The lithium battery may be, for example, a solid battery. The solid battery is not particularly limited, and may be, for example, a multi-layered ceramic (MLC) battery. Such a battery will be described in detail below.

### Solid Battery

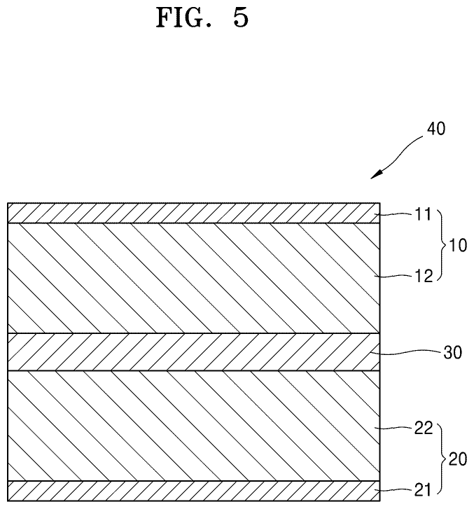

FIGS. 5 to 7 are schematic views of solid batteries 40 and 40a according to an embodiment.

In reference to FIGS. 5 to 7, a cathode 10 may be manufactured by forming a cathode active material layer 12 including a cathode active material on a cathode current collector 11. The cathode active material layer 12 may be formed by a vapor-phase method or a solid-phase method. The vapor-phase method may be, but is not limited to, pulse laser deposition (PLD), sputtering deposition, chemical vapor deposition (CVD), or the like, and any method that can be used in the related technical field may be used. The solid-phase method may be, but is not limited to, a sintering method, a powder pressing method, or the like, and any method that can be used in the related technical field may be used. The liquid-phase method may be, but is not limited to, a sol-gel method, a doctor blade method, a screen printing method, a slurry casting method, or the like, and any method that can be used in the related technical field may be used.

The cathode active material layer 12 may be prepared as follows. A cathode active material composition is prepared by mixing a cathode active material, a conductive material, a binder, and a solvent. The cathode 10 is manufactured by directly coating the cathode current collector 11 thereon with the cathode active material composition, or may be manufactured by casting the cathode active material composition on a support, peeling the composition from the support to obtain a film, and then laminating the obtained film on the cathode current collector 11 to manufacture the cathode 10. Alternatively, the cathode 10 may be manufactured by preparing the cathode active material composition into an electrode ink including an excess amount of a solvent and printing the electrode ink on the cathode current collector 11 by an inkjet printing method or a gravure printing method. The printing method is not limited to the above method, and any method that can be used for general coating and printing may be used.

The cathode active material layer 12 includes a cathode active material.

Any cathode active material commonly used in lithium batteries may be used without limitation. The cathode active material may be, for example, a lithium transition metal oxide, a transition metal sulfide, or the like. The lithium transition metal oxide may be, for example, at least one composite oxide of lithium and a metal selected from cobalt, manganese, nickel, and combinations thereof. The cathode active material is, for example, a compound represented by one of the formulae: LiₐA_{1-b}B′_{b}D₂ (wherein, 0.90≤a≤1, 0≤b≤0.5); LiₐE_{1-b}B′_{b}O_{2-c}D_{c} (wherein, 0.90≤a≤1, 0<b≤0.5, 0≤c≤0.05); LiE_{2-b}B′_{b}O_{4-c}D_{c} (wherein, 0≤b≤0.5, 0≤c≤0.05); LiₐNi_{1-b-c}CO_{b}B′_{c}D_{α} (wherein, 0.90≤a≤1, 0≤b≤0.5, 0≤c≤0.05, 0<α≤2); LiₐNi_{1-b-c}Co_{b}B′_{c}O_{2-α}F′_{α} (wherein, 0.90≤a≤1, 0≤b≤0.5, 0≤c≤0.05, 0<α<2); LiₐNi_{1-b-c}Mn_{b}B′_{c}D_{α} (wherein, 0.90≤a<1, 0≤b≤0.5, 0≤c≤0.05, 0<α≤2); LiₐNi_{1-b-c}Mn_{b}B′_{c}O_{2-α}F′_{α} (wherein, 0.90≤a≤1, 0<b≤0.5, 0≤c≤0.05, 0<α<2); LiₐNi_{b}E_{c}G_{d}O₂ (wherein, 0.90≤a≤1, 0≤b≤0.9, 0≤c≤0.5, 0.001≤d≤0.1); LiₐNi_{b}Co_{c}Mn_{d}GₑO₂ (wherein, 0.90≤a≤1, 0≤b≤0.9, 0≤c≤0.5, 0≤d≤0.5, 0.001≤e≤0.1); LiₐNiG_{b}O₂ (wherein, 0.90≤a≤1, 0.001≤b≤0.1); LiₐCoG_{b}O₂ (wherein, 0.90≤a≤1, 0.001≤b≤0.1); LiₐMnG_{b}O₂ (wherein, 0.90≤a≤1, 0.001<b≤0.1); LiₐMn₂G_{b}O₄ (wherein, 0.90≤a≤1, 0.001≤b≤0.1); QO₂; QS₂; LiQS₂; V₂O₅; LiV₂O₅; LiI′O₂; LiNiVO₄; Li_{(3-f)}J₂(PO₄)₃ (0≤f≤2); Li_{(3-f)}Fe₂(PO₄)₃ (0≤f≤2); and LiFePO₄. In the formulae, A is Ni, Co, Mn, or a combination thereof; B′ is Al, Ni, Co, Mn, Cr, Fe, Mg, Sr, V, a rare earth element, or a combination thereof; D is O, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; Q is Ti, Mo, Mn, or a combination thereof; I′ is Cr, V, Fe, Sc, Y, or a combination thereof; and J is V, Cr, Mn, Co, Ni, Cu, or a combination thereof. The cathode active material is, for example, LiCoO₂, LiMnₓO₂ₓ (x=1, 2), LiNi₁₋ₓMnₓO₂ₓ (0<x<1), Ni_{1-x-y}CoₓMn_{y}O₂ (0≤x≤0.5, 0≤y≤0.5), LiFePO₄, TiS₂, FeS₂, TiS₃, FeS₃, or the like.

The cathode active material may be covered by a coating layer. The coating layer may be any layer known as a coating layer for the cathode active material of a multilayered ceramic battery. The coating layer is made of, for example, Li₂O—ZrO₂ (LZO).

The size of the cathode active material may be, for example, about 0.1 micrometer (μm) to about 20 μm, about 0.5 μm to about 10 μm, or about 1 μm to about 5 μm. The cathode active material may be, for example, a monocrystalline particle or a polycrystalline particle.

The shape of the cathode active material is, for example, a particle shape such as a true sphere, an ellipse, or a sphere. The particle size of the cathode active material is not particularly limited, and is within a range applicable to cathode active materials of conventional all-solid-state batteries. The content of the cathode active material of the cathode active material layer 12 is not particularly limited, and is within a range applicable to the cathode active material layer 12 of a conventional all-solid-state battery. The content of the cathode active material included in the cathode active material layer 12 may be about 80 wt % to about 99 wt %, about 80 wt % to about 95 wt %, or about 80 wt % to about 90 wt % of the total weight of the cathode active material layer 12.

The cathode active material layer 12 may further include a solid electrolyte. The solid electrolyte may include the above-described lithium-ion conductor. The content of the solid electrolyte included in the cathode active material layer 12 may be about 0.1 wt % to about 20 wt %, about 1 wt % to about 20 wt %, or about 10 wt % to about 20 wt % of the total weight of the cathode active material layer 12.

The cathode active material layer 12 may further include a conductive material, a binder, or a combination thereof.

The conductive material may include, for example, a carbon-based conductive material. The carbon-based conductive material may include, for example, carbon black, carbon fibers, graphite, fluorocarbon, or combinations thereof. The carbon black may be, for example, acetylene black, Ketjen black, Super P carbon, channel black, furnace black, lamp black, thermal black, or a combination thereof. The graphite may be natural graphite or artificial graphite. The cathode active material layer 12 may further include a metal-based conductive material, a metal oxide-based conductive material, or a polymer-based conductive material in addition to the carbon-based conductive material. The metal-based conductive material, the metal oxide-based conductive material, or the polymer-based conductive material may be, for example, a metal fiber; a metal powder such as aluminum powder or nickel powder; a conductive metal oxide such as zinc oxide or potassium titanate; or a polyethylene derivative. The content of the conductive material may be about 1 part by weight to about 10 parts by weight or about 2 parts by weight to about 7 parts by weight with respect to 100 parts by weight of the cathode active material.

The binder can improve the adhesion between components of the cathode active material layer 12 and the adhesion of the cathode active material layer 12 to the cathode current collector 11. Examples of the binder may include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-diene monomer (EPDM), sulfonated EPDM, styrene-butadiene-rubber, fluorinated rubber, copolymers thereof, or combinations thereof. The content of the binder may be about 1 part by weight to about 10 parts by weight or about 2 parts by weight to about 7 parts by weight with respect to 100 parts by weight of the cathode active material. The binder may be partially or completely removed by vaporization and/or carbonization during the sintering process of the cathode active material layer 12. The binder may be omitted.

The cathode current collector 11 may include, for example, a metal-based substrate or a carbon-based substrate. As the metal-based substrate, for example, a porous body, a mesh, a plate, or a foil, which is made of stainless steel, nickel (Ni), aluminum (Al), indium (In), copper (Cu), magnesium (Mg), titanium (Ti), iron (Fe), cobalt (Co), nickel (Ni), zinc (Zn), germanium (Ge), lithium (Li), or an alloy thereof, may be used. The cathode current collector 11 may be, for example, a sintered product of metal powder used in the above-described metal-based substrate. The carbon-based substrate may include, for example, a one-dimensional carbon-based material such as a carbon fiber or a carbon tube; a two-dimensional carbon-based material such as graphite or graphene; or a combination thereof. The cathode current collector 11 may further include a binder. The binder may be selected from the binders used in the cathode active material layer 12. The cathode current collector 11 may be omitted.

The anode 20 may be manufactured in the same manner as the cathode 10, except that an anode active material is used instead of the cathode active material. The anode 20 can be manufactured by forming an anode active material layer 22 including an anode active material on an anode current collector 21.

The anode 20 may be prepared as follows. An anode active material composition is prepared by mixing an anode active material, a conductive material, a binder, and a solvent. The anode 20 is manufactured by directly coating the anode current collector 21 thereon with the anode active material composition, or may be manufactured by casting the anode active material composition on a support, peeling the composition from the support to obtain a film, and then laminating the obtained film on the anode current collector 21 to manufacture the anode 20. Alternatively, the anode may be manufactured by preparing the anode active material composition into an electrode ink including an excess amount of a solvent and printing the electrode ink on the anode current collector 21 by an inkjet printing method or a gravure printing method. The printing method is not limited to the above method, and any method that can be used for general coating and printing may be used.

The anode active material layer 22 includes an anode active material.

The anode active material may include, for example, one or more selected from a lithium metal, a lithium metal alloy, a metal alloyable with lithium, a transition metal oxide, a non-transition metal oxide, and a carbon-based material. The lithium metal alloy is an alloy of lithium and another metal such as indium. The metal alloyable with lithium may be, for example, Si, Sn, Al, Ge, Pb, Bi, Sb, a Si—Y′ alloy (wherein Y′ is an alkali metal, an alkaline earth metal, a group 13 element, a group 14 element, a group 15 element, a group 16 element, a transition metal, a rare earth element, or a combination thereof, but not Si), a Sn—Y′ alloy (wherein Y′ is an alkali metal, an alkaline earth metal, a group 13 element, a group 14 element, a group 15 element, a group 16 element, a transition metal, a rare earth element, or a combination thereof, but not Sn), or the like. The element Y′ may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof. The transition metal oxide may be, for example, lithium titanium oxide, vanadium oxide, lithium vanadium oxide, or the like. The non-transition metal oxide may be, for example, SnO₂, SiOₓ (0<x<2), or the like.

The carbon-based material may be, for example, crystalline carbon, amorphous carbon, or a mixture thereof. The crystalline carbon may be graphite such as natural graphite or artificial graphite having an non-shaped, plate-like, flake-like, spherical or fibrous shape, and the amorphous carbon may be soft carbon (low-temperature calcined carbon) or hard carbon, mesophase pitch carbide, calcined coke, or the like. The anode active material may include, for example, a silicon oxide, a silicon-based alloy, a silicon-carbon-based material composite, tin, a tin-based alloy, a tin-carbon composite, a metal oxide, or a combination thereof.

The anode active material layer 22 may further include a solid electrolyte. The solid electrolyte may include the above-described lithium-ion conductor. The content of the solid electrolyte in the anode active material layer 22 may be about 0.1 wt % to about 50 wt %, about 1 wt % to about 40 wt %, or about 10 wt % to about 30 wt % of the total weight of the anode active material layer 22.

The anode active material layer 22 may further include a conductive material, a binder, or a combination thereof. The conductive material and the binder may be selected from the conductive materials and binders used in the cathode active material layer 12, respectively. The contents of the conductive material and binder used in the anode active material layer 22 may be selected from the contents of the conductive material and binder used in the cathode active material layer 12. The binder may be partially or completely removed by vaporization and/or carbonization during the sintering process of the anode active material layer 22. The binder may be omitted.

The anode current collector 21 may be selected from the metal-based substrate or carbon-based substrate used in the above-described cathode current collector 11.

The solid electrolyte layer 30 may include an oxide-based solid electrolyte. The solid electrolyte layer 30 may include the above-described lithium-ion conductor. The solid electrolyte layer 30 may be formed by mixing and drying a solid electrolyte including the above-described lithium-ion conductor and a binder or may be formed by pressing solid electrolyte powder including the above-described lithium-ion conductor into a certain shape. The solid electrolyte layer 30 may be formed by mixing and drying a solid electrolyte including the above-described lithium-ion conductor, a sulfide-based and/or oxide-based solid electrolyte and a binder or may be formed by pressing solid electrolyte powder including the above-described lithium-ion conductor and a sulfide-based and/or oxide-based solid electrolyte powder into a certain shape. The solid electrolyte layer 30 may be formed by mixing and drying a sulfide-based and/or oxide-based solid electrolyte and a binder or may be formed by pressing sulfide-based and/or oxide-based solid electrolyte powder into a certain shape.

The sulfide-based solid electrolyte may include, for example, lithium sulfide, silicon sulfide, phosphorus sulfide, boron sulfide, or a combination thereof.

The solid electrolyte layer 30 may further include a binder. The binder may be selected from the binders used in the cathode active material layer 12. The content of the binder used in the solid electrolyte layer 30 may be selected from the contents of the binder used in the cathode active material layer 12. The binder may be partially or completely removed by vaporization and/or carbonization during the sintering process of the solid electrolyte layer 30. The binder may be omitted.

A margin layer (not shown) may be disposed along the side surfaces of the cathode 10 and the anode 20 to surround at least a part of the cathode 10 and the anode 20. The margin layer (not shown) is disposed on the solid electrolyte layer 30, and may be disposed adjacent to the side surfaces of the cathode active material layer 12 and/or the anode active material layer 22 along the side surfaces thereof to surround at least a part of the cathode active material layer 12 and/or the anode active material layer 22. The margin layer (not shown) may be disposed in the same layer as the cathode active material layer 12 and/or the anode active material layer 22.

The margin layer (not shown) may include, for example, an insulating material or a conductive material. The margin layer (not shown) may include, for example, an insulator having an ionic conductivity of 1/100 or less or 1/1000 or less compared to that of the solid electrolyte layer 30. The margin layer (not shown) may include, for example, an insulating polymer. Examples of the Insulating polymer may include, but are not limited to, polyolefins such as polyethylene and polypropylene; polyesters such as polyethylene terephthalate (PET); polyurethanes; and polyimides.

### Non-Plated Anode

FIG. 5 is a schematic view of an all-solid-state battery 40 including a non-plated anode according to an embodiment. In an all-solid-state battery 40 including a non-plated anode, the initial charge capacity of an anode active material layer 22 during initial charging is, for example, more than 50%, 60% or more, 70% or more, 80% or more, 90% or more, or 100% or more of the initial charge capacity of a cathode active material layer 12.

The non-plated anode may be manufactured by the above-described method of manufacturing an anode of a solid-state battery.

Referring to FIG. 5, an all-solid-state battery 40 including a non-plated anode includes a solid electrolyte layer 30, a cathode 10 disposed on one side of the solid electrolyte layer 30, and an anode 20 disposed on the other side of the solid electrolyte layer 30. The cathode 10 includes a cathode active material layer 12 in contact with the solid electrolyte layer 30 and a cathode current collector 11 in contact with the cathode active material layer 12, and the anode 20 includes an anode active material layer 22 in contact with the solid electrolyte layer 30 and an anode current collector 21 in contact with the anode active material layer 22. In the all-solid-state battery 40, for example, the cathode active material layer 12 and the anode active material layer 22 are formed on both sides of the solid electrolyte layer 30, and the cathode current collector 11 and the anode current collector 21 are formed on the cathode active material layer 12 and the anode active material layer 22, respectively, thereby completing an all-solid-state secondary battery 40. Alternatively, the anode active material layer 22, the solid electrolyte layer 30, the cathode active material layer 12, and the cathode current collector 11 are sequentially stacked on the anode current collector 21, thereby completing an all-solid-state secondary battery 40.

### Plated Anode

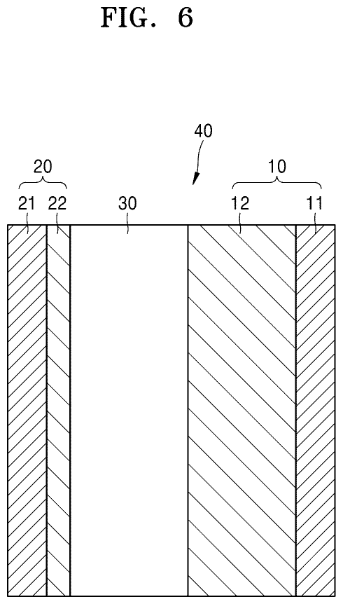

FIG. 6 is a schematic views of an all-solid-state battery including a plated anode according to an embodiment. In an all-solid-state battery 40 including a plated anode, the initial charge capacity of an anode active material layer during initial charging is, for example, 50% or less, 40% or less, 30% or less, 20% or less, 10% or less, 5% or less, or 1% or less of the initial charge capacity of a cathode active material layer. An all-solid-state battery 40 includes, for example, a cathode 0 including a cathode active material layer 12 disposed on a cathode current collector 11; an anode 20 including an anode active material layer 22 disposed on an anode current collector 21; and an electrolyte layer 30 disposed between the cathode 10 and the anode 20, wherein the cathode active material layer 12 and/or the electrolyte layer 30 include a solid electrolyte.

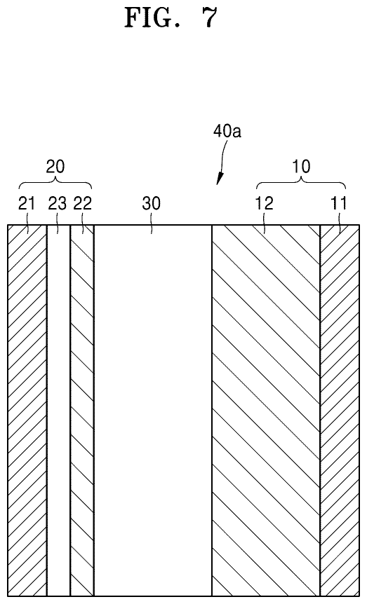

Referring to FIGS. 6 to 7, an anode 20 includes an anode current collector 21 and an anode active material layer 22 disposed on the anode current collector 21, and the anode active material layer 22 includes, for example, an anode active material and a binder.

The anode active material included in the anode active material layer 22 has, for example, a particle shape. The average particle diameter of the anode active material having a particle shape is, for example, 4 μm or less, 3 μm or less, 2 μm or less, 1 μm or less, or 900 nm or less. The average particle diameter of the anode active material having a particle shape is, for example, 10 nm to 4 μm, 10 nm to 3 μm, 10 nm to 2 μm, 10 nm to 1 μm, or 10 nm to 900 nm. Since the anode active material has an average particle size in this range, reversible absorption and/or desorption of lithium can be facilitated during charge and discharge. The average particle diameter of the anode active material is, for example, a median diameter (D50) measured using a laser particle size distribution meter.

The anode active material included in the anode active material layer 22 includes, for example, at least one selected from a carbon-based anode active material and a metal or metalloid anode active material.

The carbon-based anode material is particularly amorphous carbon. Examples of the amorphous carbon include, but are not limited to, carbon black (CB), acetylene black (AB), furnace black (FB), ketjen black (KB), graphene, and any material classified as amorphous carbon in the relevant technical field may be used. The amorphous carbon is carbon that has no crystallinity or very low crystallinity, and is distinguished from crystalline carbon or graphitic carbon.

The metal or metalloid anode active material includes at least one selected from gold (Au), platinum (Pt), palladium (Pd), silicon (Si), silver (Ag), aluminum (Al), bismuth (Bi), tin (Sn), and zinc (Zn), but is not necessarily limited thereto. Any metal or metalloid anode active material that forms an alloy or compound with lithium in the related technical field may be used. For example, since nickel (Ni) does not form an alloy with lithium, it is not a metal anode active material.

The mixing ratio of a mixture of amorphous carbon and gold, or the like, is, for example, about 10:1 to about 1:2, about 5:1 to about 1:1, or about 4:1 to about 2:1 in a weight ratio, but is not necessarily limited to this range and is selected according to the characteristics of the required all-solid-state battery 40. Since the anode active material has such a composition, the cycle characteristics of the all-solid-state battery 40 are further improved.

Examples of the binder included in the anode active material layer 22 may include, but are not limited to, styrene-butadiene rubber (SBR), polytetrafluoroethylene, polyvinylidene fluoride, polyethylene, vinylidene fluoride/hexafluoropropylene copolymers, polyacrylonitrile, and polymethyl methacrylate. Any binder used in the related technical field may be used. The binder may consist of a single binder or a plurality of different binders.

The anode active material layer 22 may further include additives used in conventional all-solid-state batteries 40, such as a filler, a coating agent, a dispersant, and an ion conductive assistant.

The thickness of the anode active material layer 22 is, for example, 50% or less, 40% or less, 30% or less, 20% or less, 10% or less, or 5% or less of the thickness of the cathode active material layer 12. The thickness of the anode active material layer 22 is, for example, about 1 μm to about 20 μm, about 2 μm to about 10 μm, or about 3 μm to about 7 μm. When the thickness of the anode active material layer 22 is too thin, lithium dendrites formed between the anode active material layer 22 and the anode current collector 21 cause the anode active material layer 22 to collapse, thereby making it difficult to improve the cycle characteristics of the all-solid-state battery 40. When the thickness of the anode active material layer 22 increases excessively, the energy density of the all-solid-state battery 40 decreases, and the internal resistance of the all-solid-state battery 40 due to the anode active material layer 22 increases, thereby making it difficult to improve the cycle characteristics of the all-solid-state battery 40.

Referring to FIG. 7, an all-solid-state battery 40a may further include a metal layer 23 disposed between the anode current collector 21 and the anode active material layer 22. The metal layer 23 may be a metal foil or a plated metal layer. The metal layer 23 includes lithium or a lithium alloy. Therefore, the metal layer 23 acts as a lithium reservoir. Examples of the lithium alloy may include, but are not limited to, a Li—Al alloy, a Li—Sn alloy, a Li—In alloy, a Li—Ag alloy, a Li—Au alloy, a Li—Zn alloy, a Li—Ge alloy, and a Li—Si alloy, and any lithium alloy used in the related technical field may be used. The metal layer 23 may be made of one of these alloys, may be made of lithium, or may be made of several types of alloys.

The thickness of the metal layer 23 is not particularly limited, but is, for example, about 1 μm to about 200 μm, about 1 μm to about 100 μm, about 1 μm to about 70 μm, about 1 μm to about 50 μm, about 1 μm to about 30 μm, or about 1 μm to about 20 μm. When the thickness of the metal layer 23 is too thin, it is difficult for the metal layer 23 to perform the role of a lithium reservoir. When the thickness of the metal layer 23 is too thick, the mass and volume of the all-solid-state battery 40 may increase, and the cycle characteristics of the all-solid-state battery 40 may deteriorate. The metal layer 23 may be, for example, a metal foil having a thickness within this range.

The anode current collector 21 is composed of, for example, a material that does not react with lithium, that is, a material that does not form both an alloy and a compound. Examples of the material constituting the anode current collector 21 include, but are not necessarily limited to, copper (Cu), stainless steel, titanium (Ti), iron (Fe), cobalt (Co), and nickel (Ni), and any material that can be used as an electrode current collector in the related technical field may be used. The anode current collector 21 may be composed of one of the above-described metals, or may be composed of an alloy of two or more metals or a coating material. The anode current collector 21 is, for example, in the form of a plate or a foil.

### Multilayered Ceramic (MLC) Battery

A multilayered ceramic battery includes, for example, a plurality of cathodes; a plurality of anodes alternately arranged between the plurality of cathodes; and solid electrolyte layers alternately arranged between the plurality of cathodes and the plurality of anodes. The solid electrolyte layer includes the above-described lithium-ion conductor.

The multilayered ceramic battery may be, for example, a sintered body of a laminate in which a cathode active material composition, an anode active material composition, and a precursor for solid electrolytes are sequentially laminated. The precursor for solid electrolytes may include the above-described precursor glass. The multilayered ceramic battery may be a laminate in which a cathode active material, an anode active material, and a solid electrolyte are sequentially laminated, or a sintered body of such a laminate.

The cathode active material composition may include a cathode active material and a binder. The cathode active material composition may further include a conductive material. As the binder and conductive material, the binder and conductive material mentioned in the cathode of the all-solid-state secondary battery may be used.

The cathode active material composition may include a precursor (precursor glass) for forming the above-described lithium-ion conductor. This precursor for forming the lithium-ion conductor may be converted into a solid lithium-ion conductor during the co-sintering process of a laminate to be described later.

The multilayered ceramic battery has a laminated structure in which a plurality of unit cells, in each which a cathode including a cathode active material layer; a solid electrolyte layer; and an anode including an anode active material layer are continuously arranged in sequence, are laminated so that the cathode active material layer and the anode active material layer face each other. The multilayered ceramic battery may further include, for example, a cathode current collector and/or an anode current collector. When the multilayered ceramic battery includes the cathode current collector, the cathode active material layer may be disposed on both sides of the cathode current collector. When the multilayered ceramic battery includes the anode current collector, the anode active material layer may be disposed on both sides of the anode current collector. Since the multilayered ceramic battery further includes the cathode current collector and/or the anode current collector, the high-rate characteristics of the battery can be further improved. In the multilayered ceramic battery, a unit cell is laminated by providing a current collector layer on one or both of the uppermost and lowermost layers of the laminate, or by interposing a metal layer in the laminate. Multilayered ceramic batteries or thin-film batteries are small or ultra-small batteries that can be applied as power sources for applications such as Internet of Things (IoT) and power sources for wearable devices. Multilayered ceramic batteries or thin-film batteries can also be applied to medium and large-sized batteries, such as electric vehicles (EVs) and energy storage systems (ESS).

The anode included in the multilayered ceramic battery includes, for example, at least one anode active material selected from lithium metal phosphate, lithium metal oxide, metal oxide, and a carbon-based anode active material.

Examples of the carbon-based anode active material include amorphous carbon, crystalline carbon, porous carbon, and combinations thereof. Examples of the crystalline carbon may include graphite, such as natural graphite or artificial graphite, which is non-shaped, plate-like, flake-like, spherical, or fibrous.

Examples of the amorphous carbon may include carbon black (CB), acetylene black (AB), furnace black (FB), ketjen black (KB), graphene, soft carbon or hard carbon, mesophase pitch carbide, and calcined coke. The amorphous carbon, as carbon that has no crystallinity or very low crystallinity, is distinguished from crystalline carbon.

The carbon-based anode material may be, for example, porous carbon. The volume of pores included in the porous carbon is, for example, about 0.1 centimeters cubed per gram (cm³/g) to about 10.0 cm³/g, about 0.5 cm³/g to about 5 cm³/g, or about 0.1 cm³/g to about 1 cm³/g. The average diameter of pores included in the porous carbon is, for example, about 1 nm to about 50 nm, about 1 nm to about 30 nm, or about 1 nm to about 10 nm. The BET specific surface area of the porous carbon is, for example, about 100 meters squared per g (m²/g) to about 3000 m²/g.

The anode active material is a compound selected from Li_{4/3}Ti_{5/3}O₄, LiTiO₂, LiM1ₛM2ₜOᵤ (M1 and M2 are transition metals, and s, t, u are any positive numbers), TiOₓ (0<x≤3), and LiₓV₂ (PO₄)₃ (0<x≤5). The anode active material according to an embodiment may be Li_{4/3}Ti_{5/3}O₄, LiTiO₂, or a combination thereof.

The cathode included in the multilayered ceramic battery includes a cathode active material. The cathode active material may be selected from cathode active materials used in all-solid-state secondary batteries. The cathode active material includes at least one selected from lithium metal phosphate and lithium metal oxides, and for example, includes lithium cobalt oxide, lithium iron phosphate, lithium nickel cobalt manganese oxide, lithium nickel cobalt aluminum oxide, lithium nickel cobalt manganese aluminum oxide, or a combination thereof.

The current collector layer can either function as a cathode current collector and/or an anode current collector. The current collector layer may be made of any metal of Ni, Cu, Ag, Pd, Au, and Pt. The current collector layer may be made of an alloy including any one of Ni, Cu, Ag, Pd, Au, and Pt. The alloy may be, for example, an alloy of two or more selected from Ni, Cu, Ag, Pd, Au, and Pt. The alloy is, for example, an Ag/Pd alloy. These metal and alloy may be singular metal and alloy or may be a mixture of two or more. The current collector layer as the cathode current collector and the current collector layer as the anode current collector may use the same material or may be different from each other. Since the alloy or mixed powder including Ag and Pd can continuously and arbitrarily change a melting point from the melting point (962° C.) of silver to the melting point (1550° C.) of palladium by a mixing ratio, the melting point thereof can be adjusted to match a batch sintering temperature, and since the alloy or mixed powder has high electronic conductivity, it can suppress an increase in the internal resistance of the battery.

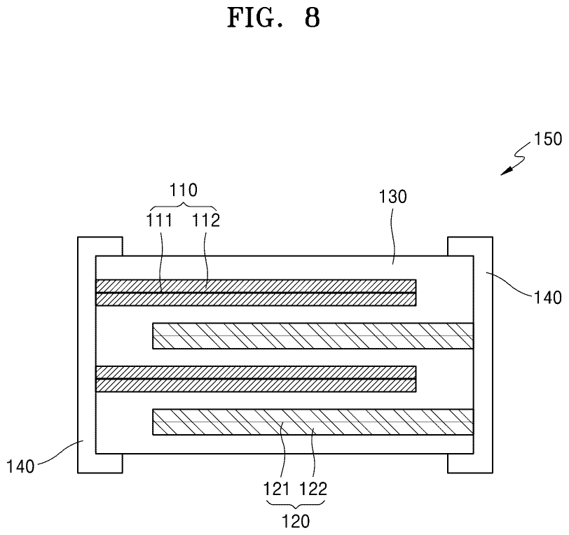

FIG. 8 is a schematic cross-sectional view of a multilayered ceramic (MLC) battery according to an embodiment. Referring to FIG. 8, a cathode active material layer 112 is disposed on both sides of a cathode current collector 111 to form a cathode 110. An anode active material layer 122 is disposed on both sides of an anode current collector 121 to form an anode 120. A composite solid electrolyte 130 according to an embodiment is disposed between the cathode 110 and the anode 120. External electrodes 140 are formed at both ends of a battery body 150. The external electrodes 140 are connected to the cathode 110 and anode 120 whose ends are exposed to the outside of the battery body 150, and serves as external terminals that electrically connect the cathode 110 and the anode 120 to an external device. One of the pair of external electrodes 140 has one end connected to the cathode 110 exposed to the outside of the battery body 150, and the other thereof has the other end connected to the anode 120 exposed to the outside of the battery body 150. The multilayered ceramic (MLC) battery 150 may be manufactured by sequentially stacking a cathode, a solid electrolyte, and an anode to form a laminate and then stacking a plurality of such laminates and simultaneously heat-treating these laminates.

A method of manufacturing a multilayered ceramic battery according to an embodiment will be described as follows.

First, a composition for forming a solid electrolyte is disposed on a substrate.

According to an embodiment, the composition for forming a solid electrolyte may include a lithium-ion conductor, and may further include a sintering agent, a solvent, or the like. The composition for forming a solid electrolyte may include a lithium-ion conductor in the form of particles or powder.

According to an embodiment, the composition for forming a solid electrolyte may a composition for forming a lithium-ion conductor including lithium, boron, an M1 element, and a halogen element.

For example, the composition for forming a lithium-ion conductor may include a mixture or molten product including lithium, boron, an M1 element, and a halogen element. Specifically, the composition for forming a lithium-ion conductor may be a mixture or molten product including Li₂O, B₂O₃, Al₂O₃, and LiCl.

The composition for forming a lithium-ion conductor may include a precursor glass or a crystal phase thereof. The composition for forming a lithium-ion conductor may include an amorphous or glassy precursor glass including lithium, boron, an M1 element, and a halogen element. The amorphous or glassy precursor glass may be prepared by melting a mixture including Li₂O, B₂O₃, Al₂O₃, and LiCl and cooling the mixture. The composition for forming a lithium-ion conductor may include a precursor glass in the form of particles or powder. Alternatively, the composition for forming a lithium-ion conductor may include a material in which the precursor glass is partially crystallized. The partially crystallized material of the precursor glass may be prepared by annealing the precursor glass at a temperature of about 200° C. to about 650° C. The composition for forming a lithium-ion conductor may include the partially crystallized material of the precursor glass in the form of particles or powder.

In the case where a film of the composition for forming a solid electrolyte has a free-standing state, the substrate may be omitted.

A cathode is formed by printing a composition for forming a cathode on a substrate and a film of the composition for forming a solid electrolyte disposed on the substrate.

The composition for forming a cathode may include a cathode active material and a binder. The cathode active material and binder may be the same as those used for an all-solid-state secondary battery. Additionally, the composition for forming a cathode may include the solid ion conductor according to an embodiment.

Subsequently, a cathode current collector and a cathode are formed on the other side of the cathode on which a film of the composition for forming a solid electrolyte is formed, thereby forming a laminate of substrate/film of composition for forming solid electrolyte/cathode/cathode current collector/cathode. The cathode current collector may be formed, for example, by printing a cathode current collector composition.

An anode is formed by printing a composition for forming an anode on the substrate and the film of the composition for forming a solid electrolyte disposed on the substrate.

The composition for forming an anode may include an anode active material and a binder. Here, the binder may be applied in the same manner as that used in an all-solid-state secondary battery.

The above-described composition for forming a cathode and composition for forming an anode may include a solvent.

An anode current collector and an anode are formed on the other side of the anode on which a film of the composition for forming a solid electrolyte is formed, thereby forming a laminate of substrate/film of composition for forming solid electrolyte/anode/anode current collector/anode. The anode current collector may be formed, for example, by printing an anode current collector composition.

The substrate is separated and removed from the laminate of substrate/film of composition for forming solid electrolyte/cathode/cathode current collector/cathode. The film of composition for forming a solid electrolyte formed by removing the substrate in this way and the film of composition for forming a solid electrolyte formed by removing the substate from the laminate of substrate/film of composition for forming solid electrolyte/anode/anode current collector/anode are laminated and pressed to form a battery structure.

Each of the cathode current collector composition and anode current collector composition includes carbon such as graphite, a metal selected from copper, aluminum, nickel, silver, gold, and alloys thereof, a conductive oxide, or a combination thereof. As a specific example, aluminum may be used in the cathode current collector, and copper may be used in the anode current collector.

The process of forming the cathode current collector and/or the anode current collector may be omitted. In other words, the battery structure according to an embodiment may not include a cathode current collector, an anode current collector, or both of them.

Next, cutting is performed on the pressed battery structure. Here, the cutting size of the battery structure varies depending on the capacity of the multilayered ceramic battery, and the battery structure is cut to a size of about 5 mm to about 15 mm in width, for example, 10 mm, and about 5 mm to about 15 mm in length, for example, 10 mm. This cutting process may be omitted.

Co-sintering on the battery structure obtained through the above process is performed, thereby manufacturing a unit cell as a cathode/current collector/cathode/solid electrolyte/anode/current collector/anode.

The co-sintering may be carried out at a pressure of about 50 MPa to about 500 MPa.

The co-sintering is carried out, for example, at 200° C. or higher and 700° C. or lower, 650° C. or lower, 600° C. or lower, or 550° C. or lower. During this co-sintering process, the film of the composition for forming a solid electrolyte is converted into a solid ion conductor. Specifically, the density of the film of the composition for forming a solid electrolyte can be improved. The composition for forming a lithium-ion conductor may be converted into a lithium-ion conductor according to an embodiment. The precursor glass in the composition for forming a lithium-ion conductor may be converted into a lithium-ion conductor according to an embodiment.

The plurality of unit cells obtained through the above process may be laminated, and external electrodes may be formed, thereby manufacturing a multilayered ceramic battery according to an embodiment.

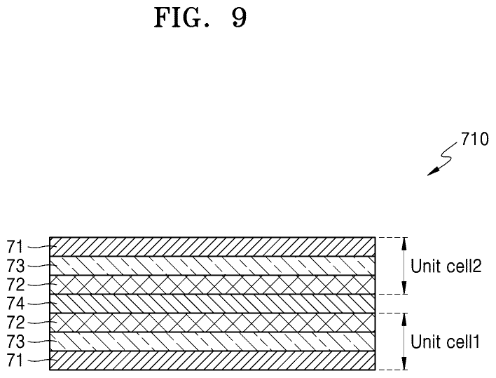

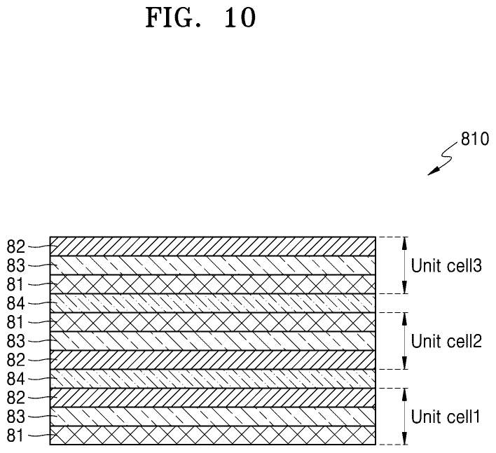

FIGS. 9 and 10 schematically illustrate cross-sectional structures of a multilayered ceramic battery according to another embodiment.

As shown in FIG. 9, in a multilayered ceramic battery 710, unit cell 1 and unit cell 2 are laminated through an internal current collector layer 74. Each of unit cell 1 and unit cell 2 is composed of a cathode 71, a solid electrolyte layer 73, and an anode 72, which are laminated in sequence. Unit cell 1, unit cell 2, and the internal current collector layer 74 are laminated so that the anode 72 of unit cell 2 is adjacent to one side surface (the upper surface in FIG. 9) of the internal current collector layer 74 and the anode 72 of unit cell 1 is adjacent to the other side surface (the lower surface in FIG. 9) of the internal current collector layer 74. In FIG. 9, the internal current collector layer 74 is disposed to contact the anode 72 of each of unit cell 1 and unit cell 2, but may be disposed to contact the cathode 71 of each of unit cell 1 and unit cell 2. The internal current collector layer 74 includes an electroconductive material. The internal current collector layer 74 may further include an ion-conductive material. When the internal current collector layer 74 further includes an ion-conductive material, voltage stabilization characteristics are improved. Since the same electrodes are arranged on both sides of the internal current collector layer 74 in the multilayered ceramic battery 710, a monopolar multilayered ceramic battery 710 in which a plurality of unit cells are connected in parallel through the internal current collector layer 74 may be obtained. In this way, a high-capacity multilayered ceramic battery 710 can be obtained. In the multilayered ceramic battery 710, the internal current collector layer 74 disposed between unit cell 1 and unit cell 2 includes an electroconductive material, so that two adjacent unit cells can be electrically connected in parallel, and simultaneously, the cathodes 71 or anodes 72 in two adjacent unit cells can be ionically connected. Thus, the potential of the adjacent cathodes 71 or anodes 72 can be averaged through the internal current collector layer 74, so that a stable output voltage can be obtained. In addition, external current collectors such as tabs may be eliminated, and unit cells constituting the multilayered ceramic battery 710 may be electrically connected in parallel. Thus, a multilayered ceramic battery 710 with excellent space utilization and economic efficiency can be obtained. Referring to FIG. 10, a laminate includes a cathode 81, an anode 82, a solid electrolyte layer 83, and an internal current collector layer 84. These laminates are laminated and thermally pressed to obtain a multilayered ceramic battery 810. The cathode 81 is composed of one cathode sheet, and the anode 82 is composed of two anode sheets.

Hereinafter, the disclosure will be described in detail with reference to Examples and Comparative Examples, but is not limited thereto.

### Preparation of Lithium-Ion Conductor

### Example 1

Li₂O, B₂O₃, Al₂O₃, and LiCl were mixed in a molar ratio of 1.5:2.0:1.5:1.0 to prepare a mixture. The mixture was added to a platinum crucible covered with an alumina crucible, and heated and melted at 1000° C. for 30 minutes to obtain a molten product. The molten product was spread on a first stainless steel substrate, pressed from above with a second stainless steel substrate, and rapidly cooled to prepare a precursor glass. The precursor glass was pulverized to obtain precursor glass powder. The precursor glass powder was formed into pellets and then annealed in an air atmosphere at 450° C. for 1 hour.

The annealed pellets were then hot-pressed in air at 500° C. for 0.5 hours under a pressure condition of 250 MPa to prepare the lithium-ion conductor in the form of a pellet.

### Example 2

A lithium-ion conductor was prepared in the same manner as in Example 1, except that the annealing temperature of the pellets of precursor glass powder was 500° C. for 1 hour.

### Example 3

A lithium-ion conductor was prepared in the same manner as in Example 1, except that annealing temperature of the pellets of precursor glass powder was 400° C. for 1 hour.

### Example 4

A lithium-ion conductor was prepared in the same manner as in Example 1, except that annealing temperature of the pellets of precursor glass powder was 300° C. for 1 hour.

### Example 5

A lithium-ion conductor was prepared in the same manner as in Example 1, except that annealing temperature of the pellets of precursor glass powder was 350° C. for 1 hour.

### Comparative Example 1

A lithium-ion conductor was prepared in the same manner as in Example 1, except that annealing was omitted.

### Comparative Example 2

A lithium-ion conductor was prepared in the same manner as in Example 1, except that annealing temperature was 700° C. for 1 hour.

### Evaluation Example 1: XRD Analysis (I)

XRD spectra were obtained for the lithium-ion conductors prepared in Examples 1 to 5 and Comparative Examples 1 to 2, and the spectra of Example 1 and Comparative Examples 1 to 2 are shown in FIGS. 1 and 2. FIG. 2 is a partially expanded view of FIG. 1. XRD spectra were measured using Cu Kα radiation (1.54056 Å).

As shown in FIGS. 1 and 2, the lithium-ion conductor of Example 1 exhibited a second peak at a diffraction angle (2θ) of 23.8° and a second-a peak at a diffraction angle (2θ) of 27.5° derived from a first phase, a third peak at a diffraction angle (2θ) of 25.3° derived from a second phase, and a first peak at a diffraction angle (2θ) of 23.9° derived from a third phase.

The lithium-ion conductor of Comparative Example 1 exhibited a second peak derived from the first phase, a second-a peak at a diffraction angle (2θ) of 27.7° derived from the first phase, and a third peak derived from the second phase, but did not exhibit a first peak derived from the third phase. For the lithium-ion conductor of Comparative Example 1, it was confirmed through Rietveld refinement that the first phase included a first compound having a composition of Li₄B₄Al₃O₁₂Cl, and the second phase included a second compound having a composition of Li₄B₇O₁₂Cl.

The lithium-ion conductor of Comparative Example 2 exhibited a second peak and a second-a peak derived from the first phase, but did not exhibit a third peak derived from the second phase and a first peak derived from the third phase. For the lithium-ion conductor of Comparative Example 2, it was confirmed through Rietveld refinement that the first phase included a first compound having a composition of Li₄B₄Al₃O₁₂Cl.

It was confirmed that the lithium-ion conductor of Example 1, unlike the lithium-ion conductors of Comparative Examples 1 and 2, further included a first peak at a diffraction angle (2θ) of 23.9° derived from the third phase.

For the lithium-ion conductor of Example 1, it was confirmed through Rietveld refinement that the first phase included a first compound having a composition of Li₄B₄Al₃O₁₂Cl, the second phase included a second compound having a composition of Li₄B₇O₁₂Cl, and the third phase includes a third compound having a composition of Li₄B_{q}AlᵣO₁₂Cl (4<q<7, 0<r<3).

### Evaluation Example 2: XRD Analysis (II)

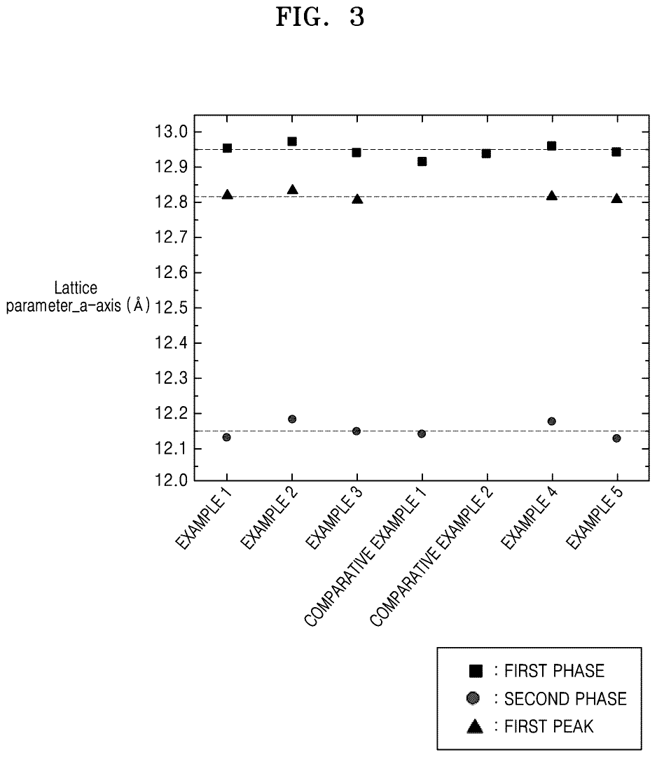

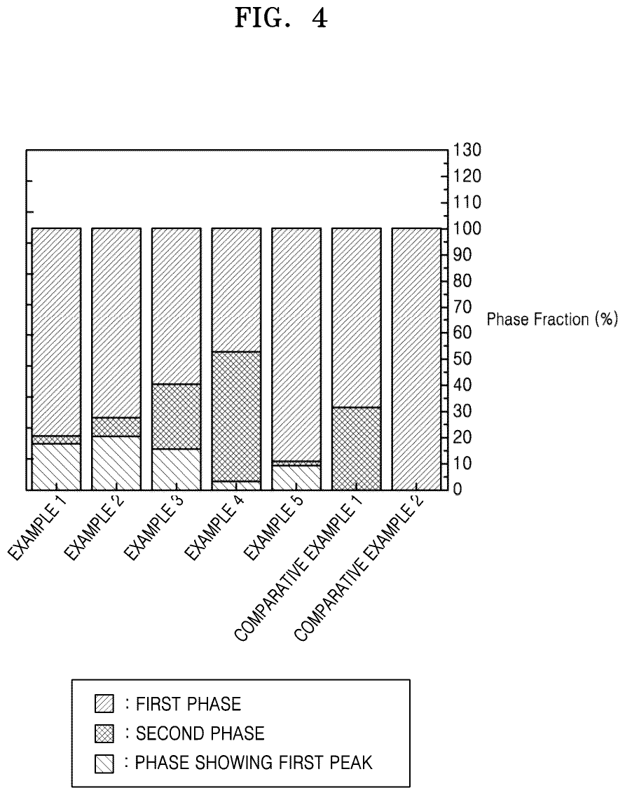

The peak intensity ratios, lattice parameters, and phase fractions of the lithium-ion conductors prepared in Examples 1 to 5 and Comparative Examples 1 to 2 were calculated, respectively, from the XRD spectra determined in Evaluation Example 1. The calculated peak intensity ratios, lattice parameters and phase fractions are shown in Table 1 and FIGS. 3 and 4.

The first peak intensity ratio is a ratio (Ic/Ia) of intensity Ic of the first peak at a diffraction angle (2θ) of 23.9° derived from the third phase to intensity Ia of the second peak at a diffraction angle (2θ) of 23.8° derived from the first phase.

The second peak intensity ratio is a ratio (Ic/Ib) of intensity Ic of the first peak at a diffraction angle (2θ) of 23.9° derived from the third phase to intensity Ib of the third peak at a diffraction angle (2θ) of 25.3° derived from the second phase.

The a-axis lattice parameters and phase fractions were calculated from the peaks derived from the first phase, the peaks derived from the second phase, and the peaks derived from the third phase, respectively, through Rietveld refinement. It was confirmed that the first, second, and third phases had a cubic structure.

TABLE 1

| | | | First phase | Second phase | Third phase | | | |
|---|---|---|---|---|---|---|---|---|
| | First | Second | a-axis | a-axis | a-axis | First | Second | Third |
| | peak | peak | lattice | lattice | lattice | phase | phase | phase |
| | intensity | intensity | parameter | parameter | parameter | fraction | fraction | fraction |
| | ratio | ratio | [Å] | [Å] | [Å] | [wt %] | [wt %] | [wt %] |
| Example 1 | 0.184 | 4.83 | 12.9544 | 12.1288 | 12.8213 | 79.4 | 2.7 | 18.0 |
| Example 2 | 0.115 | 1.62 | 12.9756 | 12.1796 | 12.8342 | 72.5 | 6.8 | 20.7 |
| Example 3 | 0.211 | 0.81 | 12.9439 | 12.1544 | 12.8076 | 59.6 | 24.9 | 15.5 |
| Example 4 | 0.079 | 0.30 | 12.9614 | 12.1736 | 12.8175 | 47.2 | 49.3 | 3.5 |
| Example 5 | 0.06 | 2.93 | 12.9454 | 12.1330 | 12.8106 | 89.1 | 1.5 | 9.4 |
| Comp. | 0 | 0 | 12.9186 | 12.1395 | — | 67.6 | 31.5 | — |
| Example 1 | | | | | | | | |
| Comp. | 0 | — | 12.9393 | — | — | 100.0 | — | — |
| Example 2 | | | | | | | | |

As shown in Table 1, the first peak intensity ratios (Ic/Ia) of the lithium-ion conductors of Examples 1 to 5 were 0.05 or more.

The second peak intensity ratios (Ic/Ib) of the lithium-ion conductors of Examples 1 to 5 was more than 0.1.

As shown in Table 1 and FIG. 3, the first phase a-axis lattice parameters of the lithium-ion conductors of Examples 1 to 5 was 12.9 Å or more, and the third phase a-axis lattice parameters thereof was 12.80 Å to 12.84 Å.

As shown in Table 1 and FIG. 4, the third phase fractions of the lithium-ion conductors of Examples 1 to 5 were 3 wt % or more, and the lithium-ion conductors of Comparative Examples 1 to 2 did not include the third phase.

### Evaluation Example 3: Measurement of Ionic Conductivity

A blocking electrode was deposited by sputtering a gold (Au) electrode with a thickness of 20 nm on both sides of each of the lithium-ion conductor pellets prepared in Examples 1 to 5 and Comparative Examples 1 to 2. Impedance was measured by a two-probe method using an impedance analyzer (Solartron 1400A/1455A impedance analyzer) for specimens with blocking electrodes formed on both sides thereof. A frequency range was 7 MHz to 1 Hz, and an amplitude voltage was 100 mV. The measurement was performed at 20° C. in air atmosphere. Resistance values were obtained from an arc of Nyquist plot for the impedance measurement results, and ionic conductivity was calculated by correcting an electrode area and a pellet thickness. The results thereof are shown in Table 2.

TABLE 2

| | Ionic conductivity |
|---|---|
| | [S/cm] |
| Example 1 | 9.0 × 10⁻⁶ |
| Example 2 | 9.4 × 10⁻⁶ |
| Example 3 | 5.9 × 10⁻⁶ |
| Example 4 | 4.0 × 10⁻⁶ |
| Example 5 | 3.8 × 10⁻⁶ |
| Comparative | 3.5 × 10⁻⁶ |
| Example 1 | |
| Comparative | 0 |
| Example 2 | |

As shown in Table 2, the lithium-ion conductors of Examples 1 to 5 exhibit improved ion conductivity as compared with the lithium-ion conductor of Comparative Example 1. The lithium-ion conductor of Comparative Example 2 had a lithium-ion conductivity of 0, and was a lithium-ion non-conductor.

### Evaluation Example 4: Measurement of Moisture Absorption Rate

The lithium-ion conductor pellets prepared in Example 1 and Comparative Examples 1 and 2 were left in an oven at a relative humidity of 70% for 7 days, and then moisture absorption rates, which are mass increase rates, were determined. The respective mass increase rates are shown in Table 3 below.

The moisture absorption rate was calculated Equation 1 below.

$$Moisture absorption rate ( \% ) = [ ( Wf - Wi ) / Wi ] \times 100 \qquad Equation 1$$

where Wf is a final pellet weight after 7 days of storage in the oven, and Wi is an initial pellet weight.

TABLE 3

| | Moisture absorption |
|---|---|
| | rate [%] |
| Example 1 | 24.0 |
| Comparative | 63.4 |
| Example 1 | |

As shown in Table 3, the lithium-ion conductor of Example 1 exhibits a reduced moisture absorption rate, that is, improved moisture stability, as compared with the lithium-ion conductor of Comparative Example 1.

According to an aspect, a novel lithium-ion conductor having improved ionic conductivity and reduced water absorption is provided.

According to another aspect, a lithium battery having reduced internal resistance and improved moisture stability is provided by including a novel lithium-ion conductor.

According to another aspect, a method of preparing a novel lithium-ion conductor is provided.

The new lithium-ion conductor can be prepared by low-temperature sintering, and can be easily mass-produced under various conditions such as air due to its reduced moisture absorption rate. The new lithium-ion conductor is suitable as a solid electrolyte for lithium batteries manufactured by sintering due to its excellent ion conductivity.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A lithium-ion conductor comprising:
a first compound represented by Formula 1; and
a second compound represented by Formula 2,
wherein the lithium-ion conductor has a first peak at a diffraction angle (2θ) of 23.8° to 24.5° in an X-ray diffraction spectrum: 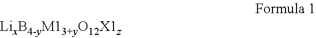
wherein, in Formula 1,
3.8≤x≤4.2, 0≤y<4, and 0.5≤z≤1.2,
M1 is at least one element belonging to groups 13 to 15 of Periodic Table, and
X1 is at least one halogen element, 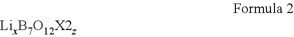
wherein, in Formula 2,
3.8≤x≤4.2 and 0.5≤z≤1.2, and
X2 is at least one halogen element.

2. The lithium-ion conductor of claim 1,
wherein the lithium-ion conductor has a second peak having a diffraction angle less than the diffraction angle of the first peak.

3. The lithium-ion conductor of claim 2,
wherein a ratio Ic/Ia of peak intensity Ic of the first peak to peak intensity Ia of the second peak is 0.05 or more.

4. The lithium-ion conductor of claim 3,
wherein the ratio Ic/Ia is 0.1 or more.

5. The lithium-ion conductor of claim 1,
where the lithium-ion conductor has a third peak at a diffraction angle (2θ) of 25.3±0.5° in the XRD spectrum, and
a ratio Ic/Ib of intensity Ic of the first peak to intensity Ib of the third peak is more than 0.1.

6. The lithium-ion conductor of claim 1,
wherein the first compound has an a-axis lattice parameter of 12.945 Angstroms or more.

7. The lithium-ion conductor of claim 1, further comprising: a third compound,
wherein the third compound has a cubic structure,
the third compound has a different a-axis lattice parameter than the first compound, and
the a-axis lattice parameter of the third compound is about 12.580 Angstroms to about 12.940 Angstroms.

8. The lithium-ion conductor of claim 7,
wherein the third compound is different from the first compound, and
the third compound comprises lithium, boron, at least one element M1 belonging to groups 13 to 15 of the Periodic Table, oxygen, and a halogen.

9. The lithium-ion conductor of claim 7,
wherein in the third compound, a content ratio of a content of boron C3_{B} to a content of element C3_{M1} belonging to groups 13 to 15 of Periodic Table, C3_{B}/C3_{M1} is greater than a content ratio of a content of boron C1_{B} to a content of element C1_{M1} belonging to groups 13 to 15 of Periodic Table, C1_{B}/C1_{M1} of the first compound.

10. The lithium-ion conductor of claim 1,
wherein the first compound is represented by Formula 4: 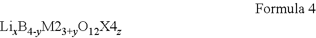
wherein, in Formula 4,
3.9≤x≤4.1, 0≤y<3, and 0.7≤z≤1.1,
M2 is Al, Ga, Si, Ge, P, or a combination thereof, and
X4 is F, Cl, Br, I, or a combination thereof.

11. The lithium-ion conductor of claim 1,
wherein the second compound is represented by Formula 5: 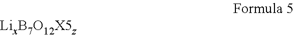
wherein, in Formula 5,
3.9≤x≤4.1 and 0.7≤z≤1.1, and
X5 is F, Cl, Br, I, or a combination thereof.

12. The lithium-ion conductor of claim 1,
wherein the lithium-ion conductor further comprises an amorphous phase, a glass phase, or a combination thereof.

13. The lithium-ion conductor of claim 1,
wherein the lithium-ion conductor has an ionic conductivity of 3.7×10⁻⁶ S/cm or greater at 20° C. and 1 atm.

14. The lithium-ion conductor of claim 1,
wherein the lithium-ion conductor has a moisture absorption rate of 30% or less, the moisture absorption rate corresponding to a mass increase rate due to moisture absorbed after leaving the lithium-ion conductor at a relative humidity of 70% for 7 days.

15. A lithium battery comprising: a cathode; an anode; and a solid electrolyte layer disposed between the cathode and the anode,
wherein at least one of the cathode, the anode, and the solid electrolyte layer comprises the lithium-ion conductor of claim 1.

16. A method of preparing a lithium-ion conductor, the method comprising:
preparing a precursor glass comprising lithium, boron, an M1 element, and a halogen element;
annealing the precursor glass to prepare an intermediate; and
pressurizing and heat-treating the intermediate to prepare a lithium-ion conductor comprising a crystal phase,
wherein the lithium-ion conductor comprises a first compound represented by Formula 1 and a second compound represented by Formula 2,
wherein the lithium-ion conductor has a peak at a diffraction angle (2θ) of 23.8° to 24.5° in an X-ray diffraction spectrum: 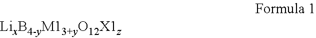
wherein, in Formula 1,
3.8≤x≤4.2, 0≤y<4, and 0.5≤z≤1.2,
M1 is at least one element belonging to groups 13 to 15 of the Periodic Table, and
X1 is at least one halogen element, 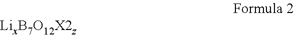
wherein, in Formula 2,
3.8≤x≤4.2 and 0.5≤z≤1.2, and
X1 is at least one halogen element.

17. The method of claim 16,
wherein the annealing of the precursor glass is performed at a temperature of 200° C. to 650° C.

18. The method of claim 16,
wherein the pressurizing and heat-treating of the intermediate is performed at a temperature of 200° C. to 700° C. under a pressure of 50 MPa to 500 MPa.

19. The method of claim 16,
wherein the preparing of the precursor glass comprises:
melting a mixture comprising Li₂O, B₂O₃, Al₂O₃, and LiCl to obtain a molten product; and
cooling the molten product to form a precursor glass comprising an amorphous phase or a glass phase.

20. The method of claim 19,
wherein the mixture comprises about 2 mole equivalents to about 4 mole equivalents of a lithium precursor, about 3 mole equivalents to about 5 mole equivalents of a boron precursor and about 2 mole equivalents to about 4 mole equivalents of an M1 element precursor, per 1 mole equivalent of a halogen precursor.
